(19) United States
(12) Patent Application Publication
(10) Pub. No.: US 2009/0089268 A1
(43) Pub. Date: Apr. 2, 2009

(54) XML Update Facility for an XQuery Processor

(76) Inventors: Michael A. Benedikt, Oxford (GB); Dinesh Venkataramanaidu, Tamilnadu (IN); Avinash Vyas, La Jolla, CA (US)

Correspondence Address: Ryan, Mason & Lewis, LLP, Suite 205, 1300 Post Road, Fairfield, CT, 06824, US

(21) Appl. No.: 11/863,888

(22) Filed: Sep. 28, 2007

(51) Int. Cl. G06F 17/30

(52) U.S. Cl. 707/4; 707/E17.07

(57) ABSTRACT

An XML update facility is disclosed for an XQuery processor A modular system for updating an XML document comprises a query generator for converting one or more updates to the XML documents into one or more queries; an existing XML query engine for processing the one or more queries to generate one or more point updates that each update a node in the XML document; an update converter that converts the one or more point updates to one or more abstract interface representations of the one or more point updates, wherein the one or more abstract interface representations are executable units that can be individually executed using a point update facility; and an update evaluator that applies the one or more abstract interface representations to the XML document to update the XML document

### FIELD OF THE INVENTION

The present invention relates to techniques for processing updates to XML data, and, more particularly, to methods and apparatus for processing updates to XML data as snapshot updates

### BACKGROUND OF THE INVENTION

XQuery has become a popular standard for querying XML documents. In contrast to the situation with querying, the only mature interface for updating XML documents has been via the Document Object Model (DOM) and Java Document Object Model (JDOM) APIs These APIs allow only point updates, i.e, updating only a single node at a time. Thus, an application needs to navigate to a particular node, and then modify that node individually However, many applications require support for application of bulk updates to XML The need to specify declarative bulk updates has resulted in several proposals for extending XQuery with updates

These proposals generally center around snapshot updates, i e., update statements whose semantics are given in terms of two phases of evaluation In the first querying phase, queries within the update statement are evaluated to produce a set of point updates, and in the second application phase, the point updates are applied to the input document For example, consider the following update statement:

```
Ul: for $x in //A
    do
        insert $x//C after $x/B;
        delete $x//D
```

FIG. 1 is an exemplary XML document 100 that illustrates the effect of this snapshot update statement over a document instance Under the snapshot semantics, evaluation of the update proceeds by first evaluating the query //A to obtain all the nodes in the document with name ‘A’ as the name. The result of this evaluation is an ordered set of nodes S₁. Then, queries $x//C, $x/B, and $x//D are evaluated with $x assigned to each node in S₁ in turn At the end of this querying phase, the results of the queries are used to obtain an ordered sequence of point updates, as shown below

insert “C id=6” after “B id=4”
delete “D id=5”
insert “C id=11” after “B id=9”

The first point update inserts a subtree rooted at node C (id attribute equal to 6), as a child of node A (id attribute equal to 3) and as a forward sibling of node B (id attribute equal to 5). The second point update deletes the subtree rooted at node D (id attribute equal to 5) In the application phase, these point updates are applied to the input document in the specified order

Influenced by these different snapshot update proposals, the World Wide Web Consortium proposed a snapshot language for adding updates to XQuery. While these snapshot languages are not as powerful as the recently proposed update language XQuery! (see, G. Ghelli et al., “XQuery!: An XML Query Language with Side Effects,” http://xquerybang.cs.washington.edu/), which allows complex interaction between querying and updates, they are generally capable of handling the needs of many XML-based applications.

The implementation of snapshot languages has not been studied in depth. For example, G. M. Sur et al., “An XQuery-Based Language for Processing Updates in XML,” PLAN-X, (2004), describes an implementation of a snapshot language in the context of a particular query engine, Galax. XQuery! is another examplary implementation. In both implementations, the update facility is tightly integrated with the underlying query engine and thus provides the opportunity to do optimizations across updates. On the other hand, the two-phase semantics of snapshot updates leads to the possibility of a modular implementation (i.e., one in which the snapshot update statements are processed by a layer on top of an existing XQuery engine and using a point update solution). A modular implementation of snapshot update statements would have the advantage that optimization of the update facility can be done without any modification of the XQuery engine In addition, a modular implementation allows portability over XQuery engines; in particular, it allows the leveraging of high-performance XQuery engines (such as Saxon and Timber) that do not yet support updates directly

A need therefore exists for improved XML update facilities for an XQuery processor. A further need exists for a modular XML update facility that can be built over an existing XQuery engine. Yet another need exists for a modular XML update facility that decouples the update facility from the query facility to allow update specific optimizations to be optionally incorporated independent of the query implementation and optimization.

### SUMMARY OF THE INVENTION

Generally, an XML update facility is disclosed for an XQuery processor. According to one aspect of the invention, a modular system is disclosed for updating an XML document. The modular system comprises a query generator for converting one or more updates to the XML documents into one or more queries; an existing XML query engine for processing the one or more queries to generate one or more point updates that each update a node in the XML document; an update converter that converts the one or more point updates to one or more abstract interface representations of the one or more point updates, wherein the one or more abstract interface representations are executable units that can be individually executed using a point update facility; and an update evaluator that applies the one or more abstract interface representations to the XML document to update the XML document.

The abstract interface representations can be implemented, for example, using the point update facility of a document object model or a stream-based point update facility (such as a pull-based streaming API). The update evaluator can also optionally employ a pull-based streaming API.

According to another aspect of the invention, the update evaluator processes a collection of the abstract representations of one or more point updates. A point update optimizer can optionally be employed to reorder the point updates. For example, the point updates can be reordered based on an order of application of the point updates in a stream representing the XML document.

A more complete understanding of the present invention, as well as further features and advantages of the present invention, will be obtained by reference to the following detailed description and drawings.

### BRIEF DESCRIPTION OF THE DRAWINGS

FIG. 1 is an exemplary XML document that illustrates the effect of an exemplary snapshot update statement over a document instance;

FIG. 2 is a flow diagram illustrating the life cycle of a snapshot update statement in accordance with the present invention;

FIG. 3 illustrates exemplary grammar for the update language employed by an illustrative embodiment of the present invention;

FIG. 4 is a schematic block diagram of an XML update architecture incorporating features of the present invention;

FIG. 5 illustrates an exemplary algorithm for processing a single snapshot update statement in the disclosed architecture of the present invention;

FIG. 6 is a sample table illustrating the FLWR expressions corresponding to different types of simple update statements;

FIG. 7 illustrates an exemplary Java API for the QueryExecutor of FIG. 4;

FIG. 8 illustrates exemplary pseudo-code for the UpdateConverter of FIG. 4;

FIG. 9 illustrates exemplary pseudo code for the executeQuery( ) method of a DOM-based Query Executor of FIG. 4;

FIG. 10 illustrates exemplary pseudo code for an implementation of the traverseToNode( ) method of the Traverser interface of FIG. 4;

FIG. 11 is a sample table illustrating the correspondence between an execute( ) method of subclasses of CUpdate of FIG. 4 and methods in the DOM API of FIG. 12;

FIG. 12 illustrates the execute( ) method of deleteCUpdate subclass of CUpdate of FIG. 4 using the DOM API;

FIG. 13 illustrates the exemplary architecture of an Update engine using Saxon for the Query Executor and DOM for the Update Evaluator of FIG. 4;

FIG. 14 is a sample table illustrating XML events that an application can access;

FIG. 15 illustrates exemplary pseudo code for the traverser of FIG. 4;

FIG. 16 illustrates exemplary pseudo code for the execute method of the insert-before CUpdate of FIG. 4;

FIG. 17 illustrates the insert-before update of CUpdate of FIG. 4;

FIGS. 18-20 illustrate the insert-into; insert-into and delete; and processing of delete-with-pending-insert-into updates, respectively;

FIG. 21 illustrates exemplary pseudo-code for the execute method of the Insert into CUpdate of FIG. 4;

FIG. 22 illustrates the insert-after update;

FIG. 23 illustrates exemplary pseudo code for processing pending updates;

FIGS. 24 and 25 illustrate the processing of exemplary pending updates;

FIG. 26 is a block diagram illustrating an exemplary StAX implementation of the disclosed architecture;

FIG. 27 provides an example of an XML document with visible node identifiers using Dewey encoding;

FIG. 28 provides an example of CUpdate ordering for the exemplary StAX2 implementation;

FIG. 29 illustrates a modified general algorithm to process a sequence of snapshot statements in the disclosed architecture; and

FIG. 30 illustrates an exemplary sequence of steps that are performed to build a complete end-to-end Update facility for XML in accordance with the present invention.

### DETAILED DESCRIPTION

The present invention provides improved XML update facilities for an XQuery processor. According to one aspect of the invention, a modular XML update facility is provided that can be built over an existing XQuery engine According to another aspect of the invention, the disclosed exemplary modular XML update facility decouples the update facility from the query facility so that update specific optimizations can optionally be incorporated independent of the query implementation and optimization.

### Overview

An update layer can first execute the querying phase by making query calls to an XQuery engine, obtaining a set of target nodes, then it can perform the application phase using some existing point update mechanism An architecture for the above mentioned approach would formalize the functionality of the XQuery engine via a query API such as the following:

query(string s): returns XQueryResult

and would capture the point update processor via an API such as the following:

delete(Node) insert(XQueryResult,Value) . . .

In this architecture, any XQuery engine and point update mechanism satisfying these APIs can be employed. For example, via a wrapper that converts XQueryResult to DOM or JDOM and then applies the update facilities of one of these interfaces for updating XML documents. There are a number of issues with this architecture.

First, most of the XQuery engines return the result of an XQuery execution as an XQueryResult object, i.e., an instance of the XQuery data model. The XQueryResult is not required to be a mutable object, or one that can be converted to a mutable DOM or JDOM object. Indeed, some of the faster XQuery processors return the result as read-only DOM objects. Thus, an architecture is needed that does not require the query engines to return mutable objects.

Second, even if the result objects can be converted to mutable objects, it may not be desired to use the particular point update API provided by that object. If the implementation of the application phase is tuned towards a particular XQuery engine's output structure, much of the benefits of the modular approach are lost. In one preferred embodiment, the architecture should allow the mixing of any query engine with any point update mechanism. Even more generally, the architecture should be able to exploit update mechanisms that can handle collections of point updates.

Finally, existing point update mechanisms like DOM and JDOM are geared towards navigational access in main-memory. For use in the bulk processing of updates in the application phase, they may not be efficient. Thus, in addition to having a flexible architecture, an efficient method is desired for processing collections of point updates.

FIG. 2 is a flow diagram illustrating the life cycle of a snapshot update statement in accordance with the present invention. As shown in FIG. 2, the XQuery Generator module 210 parses a snapshot update statement and produces an XQuery corresponding to that update statement. The generated XQuery is evaluated over the input document 220, using a standard API implemented by an off-the-shelf XQuery engine 230 The evaluation of the generated XQuery returns a list of atomic point updates. The list of point updates is then optimized by an optimizer 240 and applied to a second copy 220 of the input document using an evaluator 250. To apply a point update to the correct target node in the second copy 220 of the input document, each point update must specify the target node in a way that is independent of the mechanism used to identify nodes by the XQuery engine. Hence, the point update generated in this architecture contains visible node identifiers of the nodes to be modified in the input document.

In the exemplar implementation, an integer is used to represent the document order of a node as its visible identifier. One can also use other node identification schemes such as Dewey encoding or (Preorder, PostOrder) in place of document order. Similarly, the copy of the update content (for insert and replace updates) should also be returned in a way that is independent of the mechanism used in the Query engine.

### XML Update Language

In this section, the syntax and semantics of the exemplary implemented XML update language is discussed.

Update Language for XML

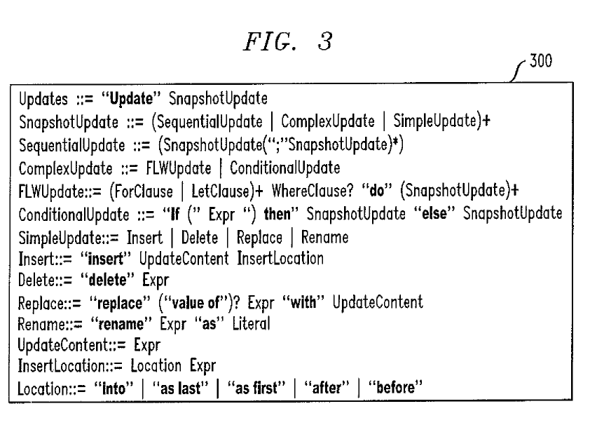

FIG. 3 illustrates exemplary grammar for the considered update language. The update language extends the PLAN-X proposal in G. M., Sur et al, referenced above, by allowing sequential composition of update statements and arbitrary nesting of updates. The Expr, ForClause, LetClause and WhereClause in the productions of the Grammar are same as those defined in the productions of the XQuery syntax specification (see, W3C. “XQuery 1.0: An XML Query Language,” http://www.w3.org/TR/xquery/ (2005)). An example of an update in this language is shown below.

```
update
    fox $var1 in //root
    do
        (for $i in $var1/A[1]
          do
            insert $i//C after $i/B;
            (fox $i in $var1/A[2]
            do
                delete $i/B;
                (if ($var1/A[3]/B[C])
                  then
                    insert <test/> after $var1/A[3]/B[1]
                  else
                    insert <test/> before $var1/A[3]/B[1]
                  )
            )
          )
```

Semantics of XML Updates

The following section informally describes the semantics of some of the constructs of the update language as proposed in G. M. Sur et al., referenced above, and M Benedikt et al., “Adding Updates to XQuery: Semantics, Optimization, and Static Analysis,” XIME-P (2005). First, the semantics of the atomic or point updates are discussed and then the snapshot semantics of high level constructs are described in terms of these atomic updates and other constructs.

Point Update API

The point updates described here correspond at a more abstract level to the data model update primitives presented in G. M. Sur et al. and mirrored in the Galax data model update API interface. Let D be an XML document, f be a forest (ordered sequence of XML documents), and n a node identifier, then a point update u, applied to the XML document D, is one of the following operations.

u=InsAft(n,f) or u=InsBef(n,f): the operation returns a new document, such that, if n ε D, each tree in f is inserted immediately after (before) the node with id n in its parent node, in the same order as in the forest f.

u=InsInto(n,f): the operation returns a new document such that, if n ε D, the trees in f are inserted after the last child of the node given by n.

u=Del(n): if n ε D, the operation returns a new document obtained from D by removing the sub-document rooted in the node associated with n.

u=Replace(n,f): the operation returns a new document Dₙ, such that, if n ε D, the trees in f replace the sub-document rooted in the node of n (in the ordering given by f).

To complete the semantic definition above, what to do if n ∉ D needs to be addressed in each case. Previous proposals differ on this issue (or leave it unspecified). One possibility, referred to as the lenient API, has each of the operations be the identity in this case. A second possibility, referred to as the strict API, aborts the update in this case. This can be considered to mean that a particular value “abort” is returned; when the snapshot update statements generate an API call that returns this value, they will be required to return abort as well Of course, there are a range of possibilities in between. One plausible middle ground is the API in which delete operations with non-referring nodeIds have no effect, but insert or replace operations on such nodeIds abort. In the exemplary implementation, the lenient API is employed

Each point update implicitly entails several operations that keep the consistency of the output document. For example, since node insertions and replacements are performed under the assumption that the sets of nodeIds in the inserted and replace documents are disjoint (if this is not the case, an assignment of fresh nodeIds to nodes must be performed).

Simple Updates

The simple updates have one-to-one mapping to the atomic updates. For each node in the node list obtained by evaluating Expr (that specify the target node) in a simple update, an atomic update is generated. For example, the simple update

insert<X/>into //A

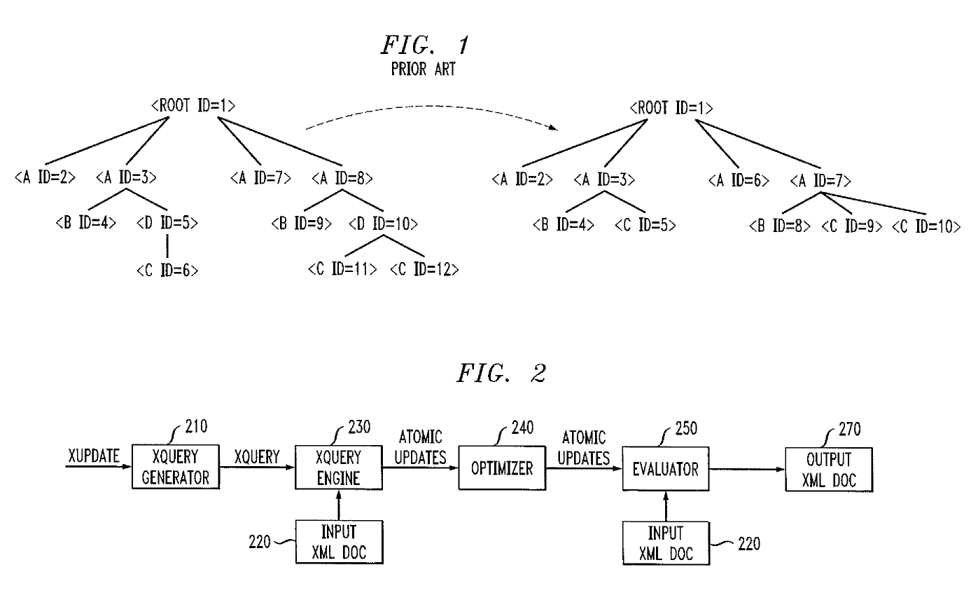

when evaluated over the left document of FIG. 1 generates the following atomic updates:

InsInto(<A id=2>, <X id=13>)

InsInto(<A id=3>, <X id=14>)

InsInto(<A id=7>, <X id=15>)

InsInto(<A id=8>, <X id=16>)

where 2, 3, 7, 8 are the (visible) node identifiers of the target nodes in the input document and 13, 14, 15, 16 are the (visible) node identifiers of the new nodes inserted in the document. All the atomic updates are generated before any atomic updates are applied.

Complex Updates

The semantics of conditional update is same as XQuery conditional expression If the Expr in the if expression returns “true,” then the snapshot update in the “then” part is evaluated as per its semantics, otherwise the update in the else part is evaluated.

The ForClause and the LetClause in the FLWUpdate defines bindings for the variables as in case of XQuery FLWR expression. While LetClause defines a single binding, the number of bindings in the ForClause is equal to the size of the node-list. For each binding, the updates in the do clause are evaluated once to generate atomic updates as per their semantics. Any atomic update generated by a sub-update in the do clause is applied only after all the bindings of the outermost ForClause have been used

Sequential Updates

Sequential updates consist of a sequence of snapshot updates. Each update in the sequence is processed as per its semantics except that atomic updates corresponding to all the updates in the sequence are generated before any update is applied to the input document

### Architecture

According to one aspect of the present invention, the disclosed architecture may be implemented using any XQuery processor and bulk point update processor. The main solution to providing this flexible architecture is to generate XQueries corresponding to update statements so that visible identifiers for target nodes are available as part of the output objects. This gives a default mechanism for converting results returned in the querying phase into handles usable in the update evaluation phase.

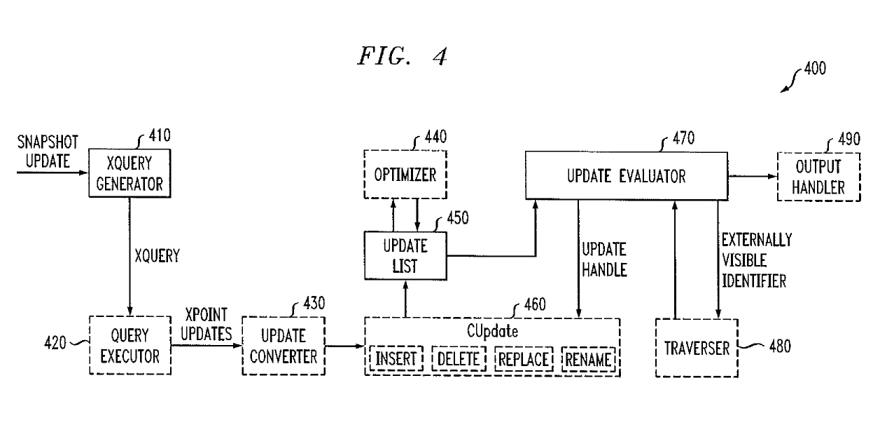

FIG. 4 is a schematic block diagram of an XML update architecture 400 incorporating features of the present invention. The disclosed architecture 400 is comprised of five main components, namely, an XQuery Generator 410, a QueryExecutor 420, an Update Converter 430, an Update Optimizer 440 and an Update Evaluator 470. The boxes 420, 430, 440, 460, 480 and 490 with broken outline represent interfaces, while the solid boxes 410, 450 and 470 represent actual Java code that works on top of these abstract interfaces. The functionality of these components is described in detail using the example update statement U1 from the background section.

The algorithm 500 for processing a single snapshot update statement in the proposed architecture is shown in FIG. 5. As shown in line 1, an update is first parsed using a Parser for the language described in the previous section. In the next step, the update is translated into an XQuery by XQuery Generator 410. The details of this process are given in the subsection entitled “XQuery Generator.” The translated XQuery is executed using the executeQuery( ) method of the QueryExecutor API, implemented using an off-the-shelf XQuery processor. This is described in the subsection entitled “QueryExecutor.” The resulting point updates are obtained as XQueryResult objects which are then prepared for execution by UpdateConverter 430 described in the subsection entitled “Update Converter.” The Optimizer 440 optimizes the list of the point updates before each update is applied by the Update Evaluator 470 to the second copy of the input document. The section “Update Optimizer” describes the Optimizer 440 and the section “Update Evaluator” explains the update evaluation in detail.

XQuery Generator

The XQuery Generator 410 takes as input a snapshot update statement and generates an XQuery such that when this XQuery is evaluated over the input document it returns a list of point updates in XML form, called xpoint update. Each xpoint update is an XML element whose tag specifies the type of the update. It has a “nodeId” attribute with value equal to the visible identifier of the target node, i.e., the node to be modified. It also has an optional “loc” attribute, which is used in some xpoint updates (e.g., insert and replace) to specify the location of the inserted/new content relative to the existing children of the target node.

For example, the generated XQuery for the update “U1” in the background section is:

```
for $x in //A
  return (
    (fox $var_key in $x/B
    return
      <INSERT nodeId=”{$var_key/@nodeId}”
      loc=“after”>{$x//C} </INSERT>),
    (for $var_key in $x//D
    return
      <DELETE nodeId =“{$var_key/@nodeId}”/>)
)
```

and the xpoint updates generated by applying this query to the document of FIG. 1 is shown in the following table:

< Insert nodeId=“4” loc=“Insert_After” > < C id=“6”/> < /Insert>
< Delete nodeId=“5”/>
< Insert nodeId=“9” loc=“Insert_After” > < C id=”11”/> < C id=”12”/>
< /Insert>
< Delete nodeId=“10”/>

As shown in the generated XQuery, the XQuery Generator 410 replaces each simple update within the snapshot update statement with a FLWR expression, converting the update statement in to an XQuery The generated XQuery ensures that an xpoint update is generated if and only if the corresponding point update is generated by the logical querying phase when the update statement is executed under (a naive implementation of) the snapshot semantics.

The generation of XQuery can be seen as a two step process. The first step is normalization, in which each simple update in the snapshot update statement is replaced by a FLWR update such that the corresponding FLWR update has the same effect as the simple update. The main motivation for doing this is to use a variable to specifying the target node within simple updates That is, the normalized update should contain no simple update that contains an XQuery expression instead of a variable to specify the target node. The resulting simple updates within these FLWR updates are referred to as a normalized simple update (i.e., a simple update with only variables specifying the target node). The query expression that specify the target node(s) in the original simple update is used to bind a variable in the ForClause of the FLWR update. This variable is then used to specify the target node in the normalized simple update. This rewriting is safe because it does not change the number of the point update, their target and the order in which they are generated by the original update.

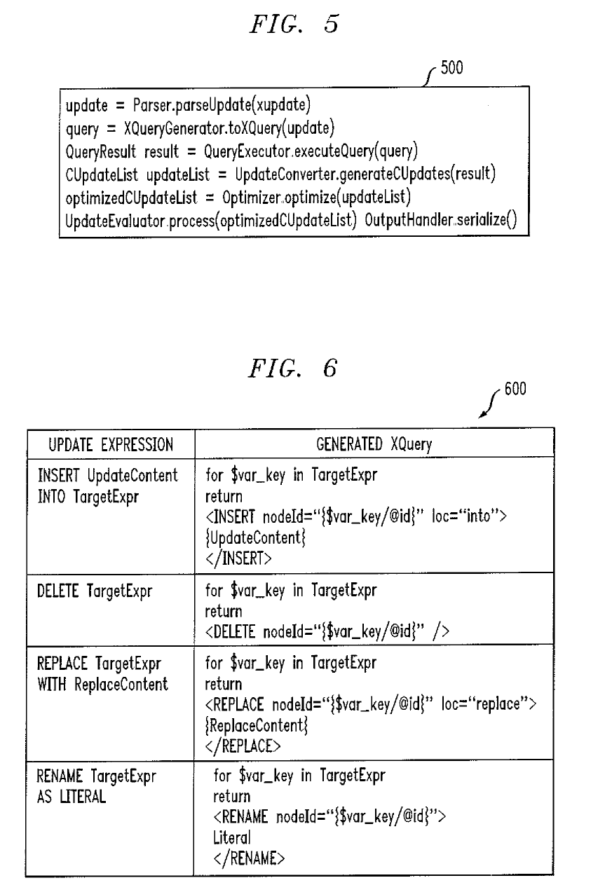

In the second step, the FLWR Update inserted in the normalization are translated to a FLWR expression. This is done by replacing each normalized simple update with a return clause containing a corresponding xpoint template. An xpoint template is an xpoint update that uses an XQuery expressions to specify the value of its “nodeId” attribute and the update content The variable bound in the ForClause of the FLWR Update, i.e., the one used in the normalized simple update to specify the target node(s), is used in a path expression that returns the visible identifier of the target node This path expression is then used to specify the value of the “nodeId” attribute in the template. The query expression corresponding to the update content remains unchanged but is made a sub-element of the element constructor of the xpoint update template. FIG. 6 is a table 600 illustrating the FLWR expressions corresponding to different types of simple update statements.

When the XQuery is evaluated, the expressions and variables in the xpoint templates are replaced with the bindings obtained from the ForClause to get the concrete xpoint updates.

In the example query shown previously (and in table 600 of FIG. 6), the xpoint templates use a variable called $var_key in an xpath expression to identify the target nodes. When the query is evaluated over the document shown in FIG. 1, the variable $var_key in the templates is replaced with the bindings generated by the query to produce the updates shown in the above table.

The target nodes for the point updates can be of type Element, Attribute, or Text. Since visible identifiers can only be assigned to nodes of type Element, additional information is needed in the xpoint updates to represent point updates on attributes and text nodes Hence, an additional attribute targetNodeType is included in the xpoint updates that describes the type of the target node. If the target node of a point update is an attribute or text node, the visible identifier of the parent element is used as the value of the “nodeId” attribute in corresponding xpoint update If the target node is an attribute, the xpoint update has an additional attribute, attrName In order to handle these cases, and generate the correct xpoint representation, the XQuery queries generated by XQuery Generator 410 includes a node type test to identify the type of the target node.

QueryExecutor

To keep the disclosed architecture flexible enough to be usable with any XQuery engine of our choice, the query functionality required in the processing of updates must be abstracted. Concretely, a standard API is required for executing XQuery statements but there is currently no such standard API for XQuery except for XQJ (see, “XQuery API for Java (XQJ),” http://jcp.org/aboutJava/communityprocess/edr/jsr225/), which is an ongoing Java Community Process aimed at developing such a standard. In lieu of a widely-supported standard, a Java API 700, referred to as QueryExecutor, is defined in FIG. 7.

As shown in FIG. 7, the API 700 has four different methods for executing an XQuery over a given document. The methods to execute queries expects the XQuery in either a string form or as a File containing the XQuery. The input document is given as either a File or as an InputStream. All the methods return the result as a QueryResult object. The QueryResult object hides the XQuery engine specific details and keep the other components of the architecture independent of the choice of XQuery engine used to implement this API. In turn, one needs to translate the output of the query engine into a QueryResult object. As shown in the exemplary implementation, a smart choice of QueryResult object can make this task trivial. The API also defines exceptions to report different errors during query execution.

Before the XQuery generated corresponding to an Update can be executed and xpoint updates can be generated containing the visible identifiers that specify the target nodes, a pre-processing step is needed to add these visible identifiers to nodes in the input document. This is done in the initialization of QueryExecutor using the Init( ) method.

Update Converter

Similar to the QueryResult object that provides an abstraction for the XQuery engine's representation of xpoint updates, an abstraction is needed for xpoint update's representation as required by the Update Evaluator implementation. For this, the CUpdate class is used, that represents an executable xpoint update. Given an UpdateHandle, the CUpdate object 460 has a method for executing itself. The UpdateHandle is an object containing information required to execute the point update, e.g., pointer to the target node in the document It also has a method to get and set the identifier representing the target node. That is, all CUpdates 460 inherit from this signature:

void Execute(UpdateHandle UH);

Identifier getTargetNodeId( )

void SetTargetNodeId(Identifier id)

Identifier here is a class representing the choice of visible node identifier (i.e., in the exemplary implementation, it wraps an integer).

In order to facilitate the translation of an xpoint update in the QueryResult object into a CUpdate 460, the Update Converter 430 defines an API, as follows:

CUpdate createInsertUpdate(XPointUpdate u);

CUpdate createDeleteUpdate(XPointUpdate u);

CUpdate createReplaceUpdate(XPointUpdate u);

CUpdate createRenameUpdate(XPointUpdate u);

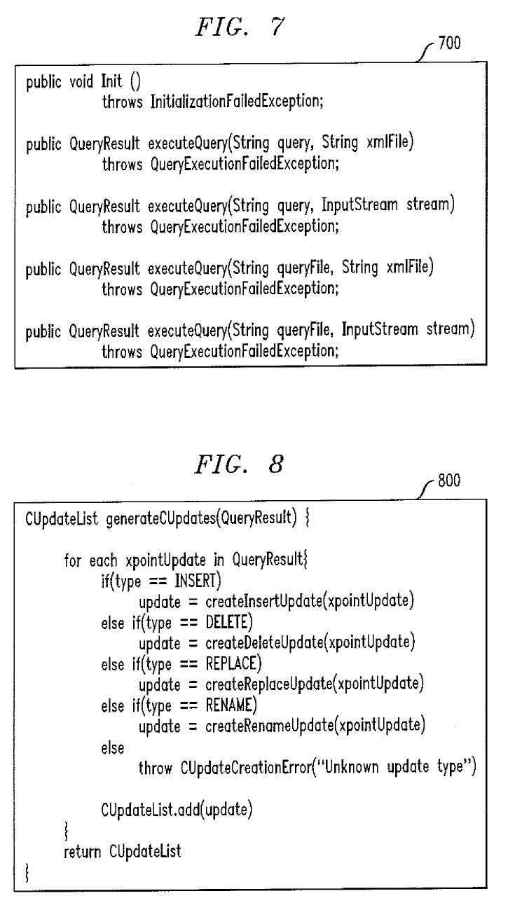

Any implementation of the Update Evaluator 470, must also implement this API. The pseudo-code 800 shown in FIG. 8 uses the implementation of the above API. Although the actual implementation of UpdateConverter 430 depends upon the point update facility used to implement the Update Evaluator 470, a generic algorithm is provided.

Update Optimizer

One of the goals of the disclosed modular architecture is to provide the flexibility of incorporating update specific optimizations independent of the query implementation. One such update specific optimization is to change the order in which the point updates are applied to the input document. This is a heuristic based optimization where the ordering depends upon the bulk point update processor. For example, a stream based point update processor can benefit by reordering the updates in document order of the target node. Similarly, a secondary storage based point update processor can benefit from using an ordering that suits its indexing scheme and reduces the cost of maintaining the indices One can use this optimization only in the case when changing the order of the point updates does not change the result of the update. In the exemplary implementation, it is assumed that the lenient semantics for point updates (see the discussion above), hence changing the order in which the point updates are applied does not change the result.

Here, it is shown how the disclosed architecture allows any ordering to be implemented efficiently. The generic optimizer framework provides a pair of abstract interfaces for incorporating reordering of one's choice. It provides CUpdateList, an abstract class to represent the list of point updates and CUpdateListCriteria an interface for implementing different reordering policies. In order to implement a specific ordering of point updates, one only needs to provide the implementation of the following two abstract methods within CUpateListCriteria.

int compare(CUpdate update1, CUpdate update2);

List nodeFilter(List updateList);

Update Evaluator

The evaluation phase is controlled by the Update Evaluator 470 which may be implemented as a bulk point update processor. The Update Evaluator 470 executes the optimized list of CUpdates using a set of interfaces, namely, Traverser, CUpdate, and OutputHandler. The Update Evaluator 470 has a Process( ) method that uses interfaces and applies the point updates to the second copy of the input document. The pseudo-code for the process( ) method may be expressed as:

```
for each CUpdate in optimizedCUpdateList{
  id = CUpdate getTargetNodeId( )
  updateHandle = Traverser traverseToNodeId(id)
  CUpdate execute(updateHandle)
}
Traverser postUpdateActions( )
```

The process( ) method iterates over the optimized CUpdateList, and for each CUpdate reads the visible identifier of the target node using its getTargetNodeId( ) method. The process( ) method uses the Traverser 480 to navigate to the target node in the document being modified. The Traverser 480 returns an Update Handle for the target node. An Update Handle object abstracts the Update Evaluator specific details of the structures required to execute the CUpdate. In particular, it contains a pointer to the target node of that CUpdate. The CUpdate's execute( ) method uses this update handle to apply the point update.

The CUpdate, as mentioned above, represents an executable point update generated by the Update Converter 430 from the xpoint updates The Traverser 480 is used mainly for navigating in the document being modified. It defines an abstract API to accomplish this:

DocumentHandle Init( );

UpdateHandle traverseToNode(Identifier id);

void skipCurrentNode( );

void preUpdateTraverserActions( );

void postUpdateTraverserActions( );

The Init( ) method is used to initialize the Update evaluator 470, which includes updating or adding visible identifiers to the nodes of the input document. The traverseToNode( ) is important, given the visible identifier of a node, it is supposed to return an Update handle that can be used to execute any CUpdate on that node. Additionally, the traverser 480 also provides methods for performing pre- and post-processing actions for a point update execution.

The final component, OutputHandler 490, provides an interface to serialize the output document after processing the updates.

Building XML Update Facility

The disclosed architecture 400 allows an XML update facility to be built using essentially any XQuery engine and bulk point update processor. One only needs to provide implementations of the required interfaces, namely,

use an existing XQuery engine to implement the Query Executor API 420.

use a particular document traversal facility and the associated point update facility to implement the Traverser 480 and CUpdate 460 interfaces, creating a bulk point update facility.

depending upon the above two choices, provide an implementation of Update Converter 430 that generates a list of CUpdates 460 from the XQueryResult object obtained from Query Executor 420.

implement the CUpdateList and CUpdateListCriteria interfaces of the Optimizer 440 to incorporate the reordering of CUpdates appropriate for bulk point update facility created above.

finally implement the Output Handler 490 and attach the Traverser 480 and Output Handler 490 to the (singleton) Update Evaluator 470.

### Instantiations of the Architecture

In this section, an end-to-end update engine is built by implementing the various interfaces of the disclosed architecture described in the previous section, to build an end-to-end update engine. In particular, the implementation of two update engines is described based on two different point update facilities. A novel stream based update engine is described that is built using a pull based streaming API (StaX, see, “StAX: The Streaming API for XML,” http://stax.codehaus.org/) for XML and a second, using the well known DOM API.

Query Executor

In one exemplary embodiment, Saxon (see, M. Kay, “SAXON, The XSLT and XQuery Processor,” http://saxon.sourceforge.net/), a high performance open source XQuery engine, is employed to implement the Query Executor interface 420 in both of the update engines implementation Saxon's API includes methods that execute an XQuery given as a string and return the result as either a DOM node-list or a stream. An example of a method in the Saxon API to execute an XQuery expression is:

XQueryExpression.run(DynamicQueryContext env, javax.xml.transform.Result result,

java,.util Properties outputProperties)

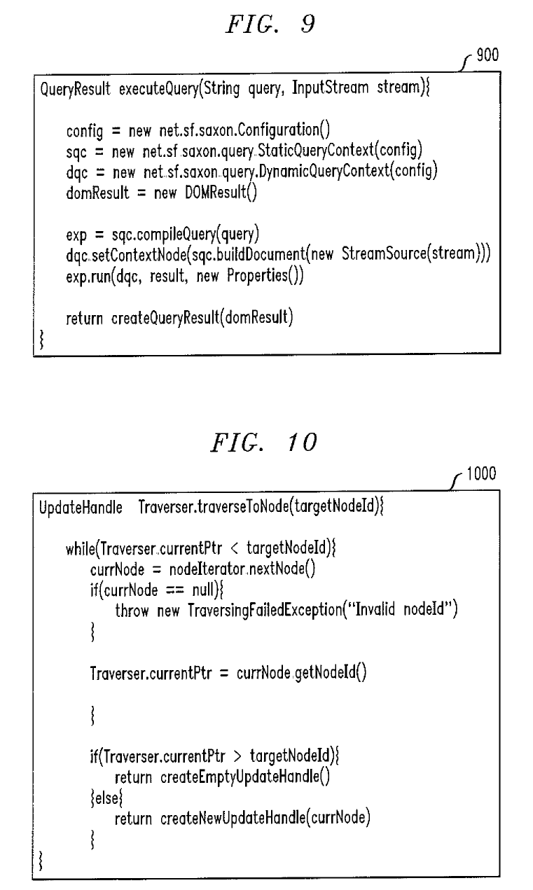

The method is used that returns the result as a DOM node-list to implement the Query Executor 420 in the DOM based update engine and the method that returns the result as a stream, to implement the Query Executor 420 in the StAX based implementation. This choice is made to simplify the implementation of an Update Converter 430, as described below. FIG. 9 illustrates exemplary pseudo code 900 for the executeQuery( ) method of the DOM-based Query Executor 420 using Saxon.

Update Converter

As previously indicated, the implementation of an Update Converter 430 depends upon the implementation of the Query Executor 420 and the Update Evaluator 470. Similarly, the implementation of CUpdate 460 depends upon the implementation of Update Converter 430. First, the implementation of CUpdate subclasses in the two update engines is described and then the Update converter 430 is described.

CUpdate. The member variables of the CUpdate implementation in the two update engines are described. The implementation of the execute( ) method is discussed later in the section.

In the DOM-based implementation of all the CUpdate subclasses, the visible identifier of the target node of the update is stored as integer, and the update content is stored as a Xerces DOM node-list.

Similarly, in the StAX based implementation of CUpdate subclasses the visible identifier of the target node is stored as integer, where as the update content is stored as a string

Update Content

While translating the DOM-based XQueryResult object to DOM-based CUpdate, the Update Converter 430 needs to translate the update content from the Saxon's implementation of DOM (source) to that of the Update Evaluator (target). This is done using the Update evaluator's implementation of the DOM API's import( ) function.

In the translation of stream-based XQueryResult objects to StAX-based CUpdates, the translation of update content is straightforward and the Update Converter 430 serializes the stream of update content to a string.

Optimizer

In both implementations of the Optimizer interface 440, the point updates are reordered such that their target nodes are in document order. For example, a point update P with the target node a precedes another point update Q with the target node b if a precedes b in Preorder traversal of input document. In both implementations, this ordering can potentially reduce the update evaluation time since it allows all the updates to be applied in a single scan of the input document and the list of point updates. This is particularly useful for the StAX implementation, since it keeps the number of traversals of the input stream during the application phase to a minimum. There is some gain in the case of the DOM implementation also, since for large documents frequent traversal of the DOM could lead to memory thrashing.

The CUpdates that have the same target node are ordered based on their types. They are ordered as insert before, insert after, delete, rename, replace, replace value, insert first and insert into. This ordering facilitate removal of redundant CUpdates in this phase. Specifically, if there is a delete or replace CUpdate with target node n, other CUpdates can be safely removed that have the same target node n (except for insert before and insert after) that comes after the delete or replace. In addition, if there are multiple renames with the same target node n, all but the last are removed (based on the ordering generated by the query).

Apart from removing redundant updates, this ordering is also useful in the update evaluation phase, since it ensures that no backtracking is needed within the stream representing the input document.

Update Evaluator

Two implementations are described of the Update Evaluator 470, which together with the components described in previous sections completes the implementation of the two end-to-end update engines, emphasizing the flexibility of this architecture. As mentioned previously, one of the two implementations is based on DOM, leveraging its navigation and update APIs The second implementation is a novel stream-based implementation that uses StAX (see, “StAX: The Streaming API for XML,” http://stax.codehaus.org/).

DOM Implementation

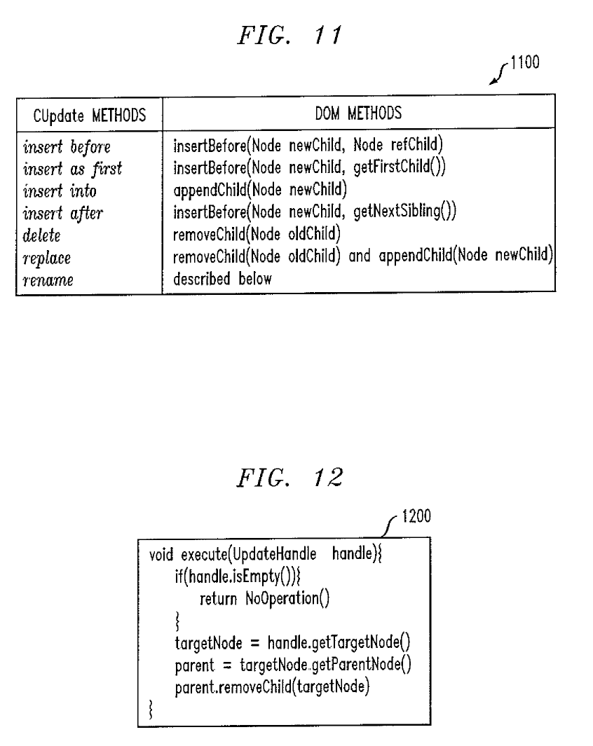

In the exemplary implementation of DOM-based Update Evaluator 470, Apache Xerces (see, Apache, “Xerces2 Java XML Parser,” http://xerces.apache.org/xerces2-j) DOM is used. The Traverser 480 is implemented using the NodeIterator interface of the DOM API. The NodeIterator has methods that allow one to step through a set of nodes in a document which match a given filtering criteria. The default implementation of the NodeIterator steps through the nodes in the document order FIG. 10 illustrates exemplary pseudo code 1000 for an implementation of the traverseToNode( ) method of the Traverser interface 480 that uses the NodeIterator.

The pseudo code 1000 iterates over the input document using the NodeIterator and compares the identifier of the target node with the identifier of each DOM node obtained from the NodeIterator. The DOM node with the matching identifier is returned as a handle that is used for executing the update.

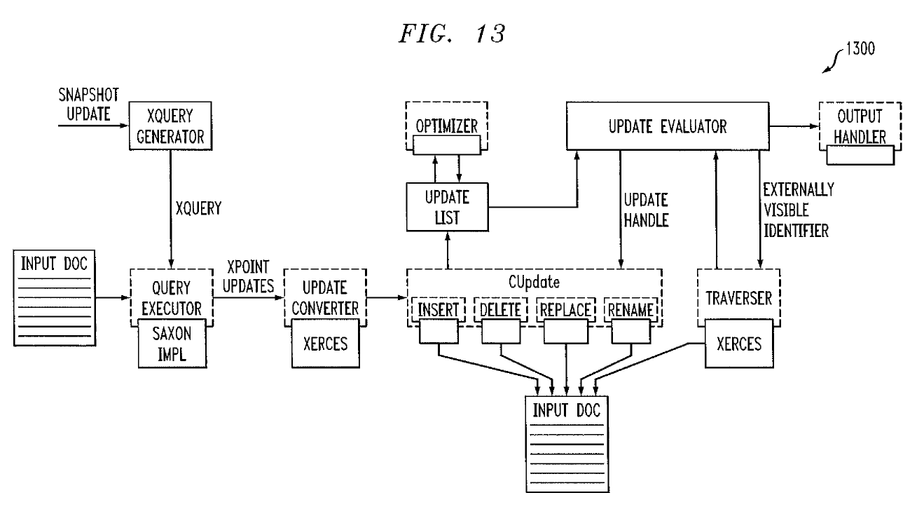

The DOM-based implementation of CUpdate's execute( ) method is straightforward, as there is one-to-one correspondence between the execute( ) method of CUpdate's subclasses and methods in the DOM API This correspondence is shown in the table 1100 of FIG. 11. The execute( ) method 1200 of deleteCUpdate subclass of CUpdate is implemented using the DOM API as shown in FIG. 12

The execute( ) method for renameCUpdate does not have a similar counterpart in the DOM2 API hence requires special handling. According to the semantics of the rename point update, it can only be applied to a node of type element or attribute. To rename an element node using DOM API, a new element node is created that has the new name. All the attributes and child nodes of the old node are copied (node that is to be renamed) and then inserted as attributes and child node in the new node. The old node can be replaced with this new node. Similarly, to rename an attribute, a new attribute node is created with the new name and value equal to value of the renamed attribute. The renamed attribute is deleted from the element and the new attribute is inserted. The DOM3 API has methods to rename a DOM node hence the above rename implementation is not required if one is using DOM3 APIs to implement the CUpdates and Update Evaluator.

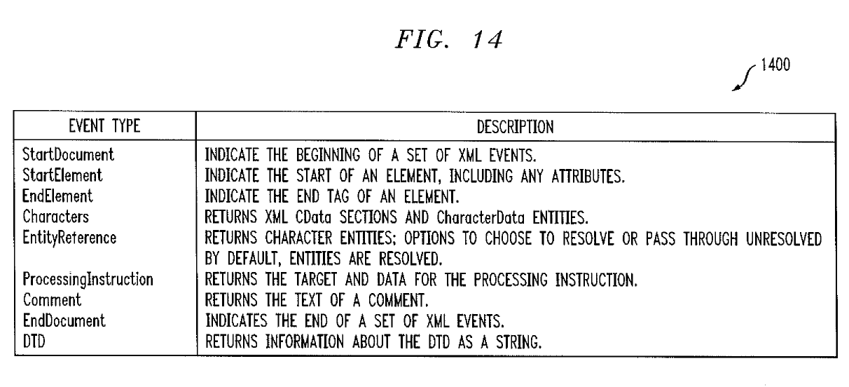

FIG. 13 illustrates the exemplary architecture 1300 of an Update engine using Saxon for Query Executor 420 and DOM for Update Evaluator 470 based on the present invention.

StAX Implementation

The stream based implementation of Update Evaluator 470 using StAX is another aspect of the present invention. StAX is a pull-based streaming API for parsing XML The StAX API is introduced and then how it is used to implement the execute methods of the different CUpdate subclasses and the Traverser is described. These are used with the stream based implementation of other components to build the first stream based XML Update engine for the snapshot update language.

The StAX API exposes methods for iterative, event-based processing of XML documents, where XML documents are treated as a filtered series of events Unlike SAX, the StAX API is bidirectional, enabling both reading and writing of XML documents. The StAX API provides two ways of processing an XML document as a stream, the cursor access and the iterator access. A brief description is provided of the iterator API here. For a more detailed discussion, see, for example, “StAX: The Streaming API for XML,” http://stax.codehaus.org/.

The StAX iterator API represents an XML document stream as a set of discrete event objects These events are read by the application using an interface called XMLEventReader. The parser generates these events in document order, i.e., the order in which they are read in the source XML document. The API also provides an interface known as XMLEventWriter for writing events. The XML events that an application can access using these interface are defined in table 1400 of FIG. 14.

Now, the use of StAX API in implementing the Traverser 480 and the execute method of different CUpdates is described. The StAX implementation of Traverser 480 uses the XMLEventReader and XMLEventWriter interfaces to scan the input document. In particular, the implementation of traverseToNode( ) method scans the input document by reading the StAX events from an input stream and then writing them back to an output stream When a START_ELEMENT event corresponding to a node is read, its visible identifier is compared with the identifier of the target node of the next CUpdate to be executed. If there is match it returns that START_ELEMENT event as a part of the UpdateHandle, used to execute that CUpdate. For some insert updates, such as insert into and insert after, the new content cannot be written to the output stream at the time their execute method is called. One has to wait till the END_ELEMENT event corresponding to the target node is read, until then, these updates are kept pending as other CUpdates are evaluated. Hence, such updates are referred to as pending updates. In the exemplary implementation, the Traverser 480 is responsible for executing any pending updates as it scans the input stream.

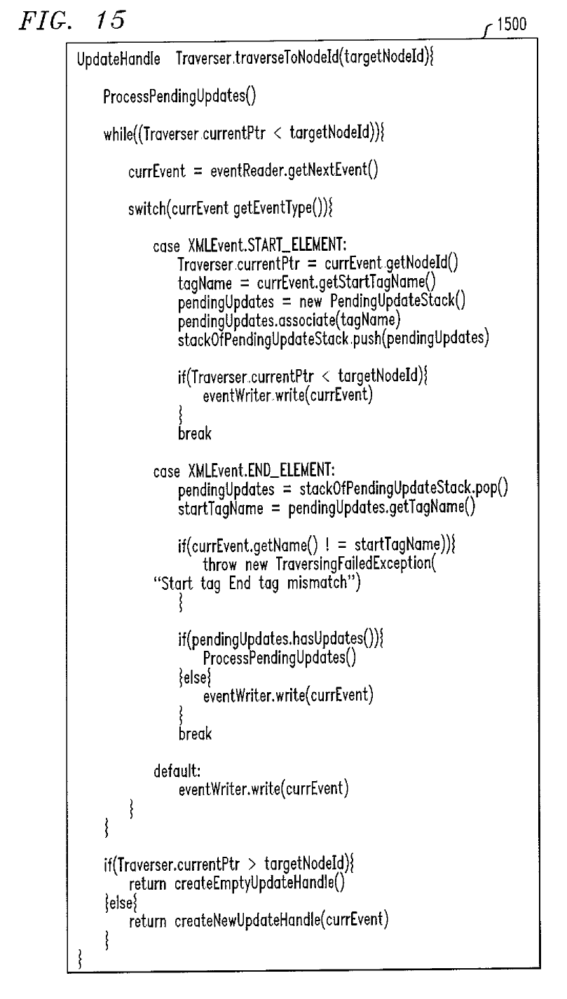

FIG. 15 illustrates exemplary pseudo code 1500 for the traverser 480.

The CUpdates are processed in the document order of their target nodes, which enables complete evaluation (of the CUpdates) in a single scan of the input document in document order. This can be done easily using the StAX based Traverser 480.

As previously indicated, the UpdateHandle that is used to execute a CUpdate includes the START_ELEMENT event of the target node. In addition, an input stream over the input document and an output stream over the modified document are also included in the UpdateHandle. The execute( ) method of a CUpdate reads events from the input stream and selectively writes them and/or new content to the output stream to apply the CUpdate.

Insert as First:

The execute( ) method of insert as-first writes the START_ELEMENT event of the target node to the output stream followed by the the insert content of the update. This simple algorithm works if there only one insert as-first on the target node. In the case when there are multiple insert as-first with the same target node, this algorithm cannot be used since it would violate the snapshot semantics. Suppose there are k insert as-first CUpdates on the same target node. The update content of the i+1ₜₕ update in this sequence should be written to the output stream before that of iₜₕ. Thus, a stack is used to reverse the order of the execution of this sequence of insert as-first updates. The execute( ) method pushes the CUpdate onto a stack Immediately before the traverser 480 is used to read the node next to the target node in the document order, the updates are popped from this stack and their update contents are written to the output stream.

Insert Before:

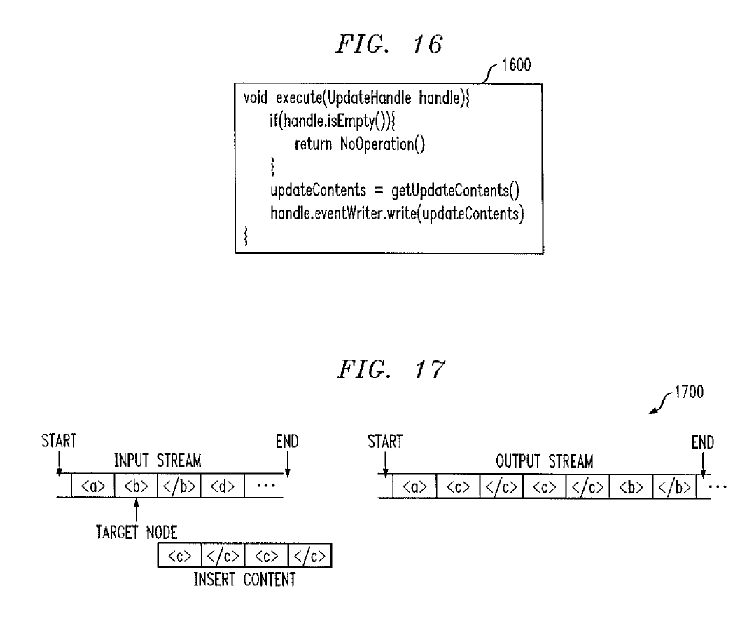

The execute( ) method of an insert-before CUpdate writes the insert content of the update to the output stream, followed by the START_ELEMENT event of the target node. FIG. 16 illustrates exemplary pseudo code 1600 for the execute method of the insert-before CUpdate The insert-before update 1700 is illustrated in FIG. 17.

Insert Into:

For an insert-into CUpdate, the update content can only be written to the output stream after all the events corresponding to all the descendant nodes of the target node have been written. Thus, after the END_ELEMENT event for the target node is read, the insert content can be written as a string, to the output stream, followed by the END_ELEMENT event FIGS. 18-20 illustrate the insert-into update 1800, the insert-into and delete update 1900 and the processing of delete with pending insert into update 2000, respectively.

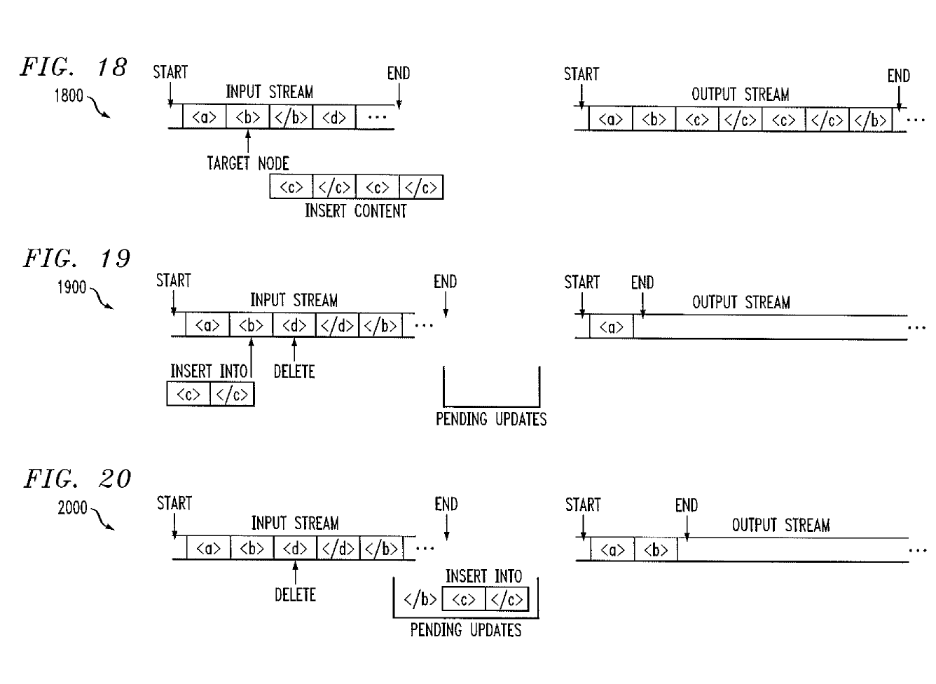

The input stream cannot be scanned and the events corresponding to the descendant nodes of the target node written in to the output stream, as there can be other CUpdate whose target node is among these descendant nodes. An example of this situation is depicted in FIG. 19. FIG. 19 shows two CUpdates, insert into with node labeled b as the target node and delete with node labeled d as the target node. To execute the insert into update, one has to scan the input stream till the end tag corresponding to node labeled b is found and then backtrack in the stream to execute the delete update thus abandoning a one-pass algorithm. One approach would be to process the delete update within the execute( ) method of insert into, but in this approach the atomicity of a CUpdate is lost. Instead, the insert-into update is marked as a pending update. A pending update is associated with the END_ELEMENT event of the target node and push it on a stack. For the example above, this is shown in FIG. 20. These pending update are processed by the traverser 480 while it scans the input stream and reads the triggering event of the pending update.

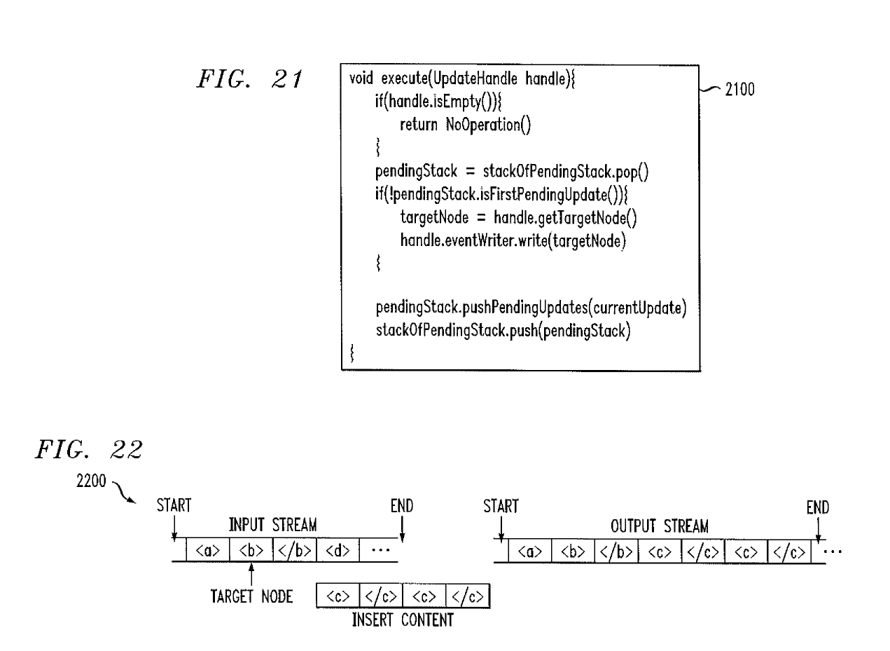

FIG. 21 illustrates exemplary pseudo-code 2100 for the execute method of the Insert into CUpdate. The method 2100 checks if the target node still exists in the document being updated (since some preceding point update could possibly delete the target node of this update). If the target node is not in the document, then the execute method 2100 returns with a no-op implementing the lenient semantics. If the target node exists, then this update is to be stored in the pending update stack associated with this target node. Since each node can be the target for pending updates, a stack is maintained of pending update stacks denoted as stackOfPending Stack in the pseudo code 2100. Additionally, if this is the first pending update associated with a target node then it writes the start tag event of the target node to the output stream.

Insert After:

As with an insert into update, the update content of an insert after update can be written to the output stream only after the events corresponding to all the descendant nodes of the target node have been written As with insert-into, this CUpdate is also processed as a pending update. The only difference is that, when the END_ELEMENT event for the target node of the pending update is read by the Traverser 480, the update content is written to the output stream after the END_ELEMENT event. FIG. 22 illustrates the insert-after update 2200.

Pending Updates:

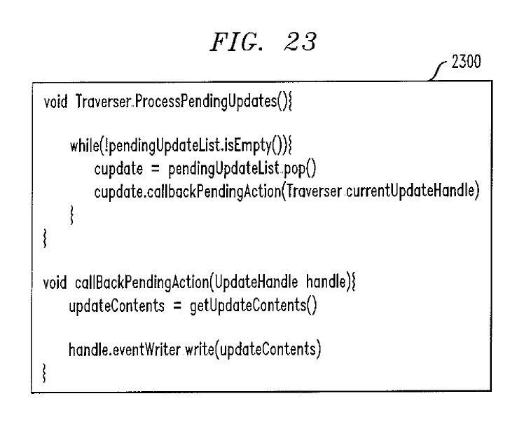

When the Traverser 480 scans the input stream to process other updates, care must be taken to process the pending updates when the END_ELEMENT event associated with them is read. FIG. 23 illustrates exemplary pseudo code 2300 for processing pending updates.

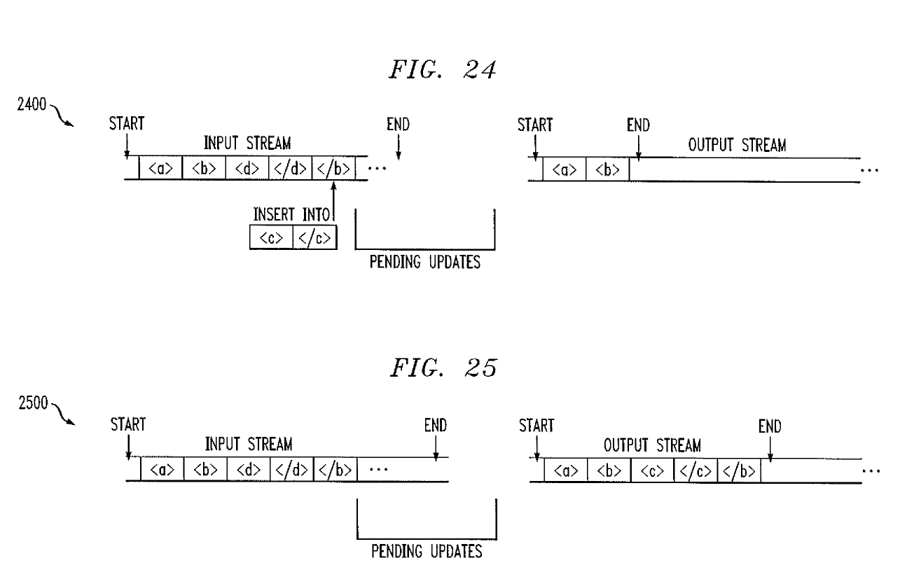

The processing of pending updates from the previous example is shown in FIGS. 24 and 25, where the insert update is processed when the end tag event of the target node is reached.

Delete:

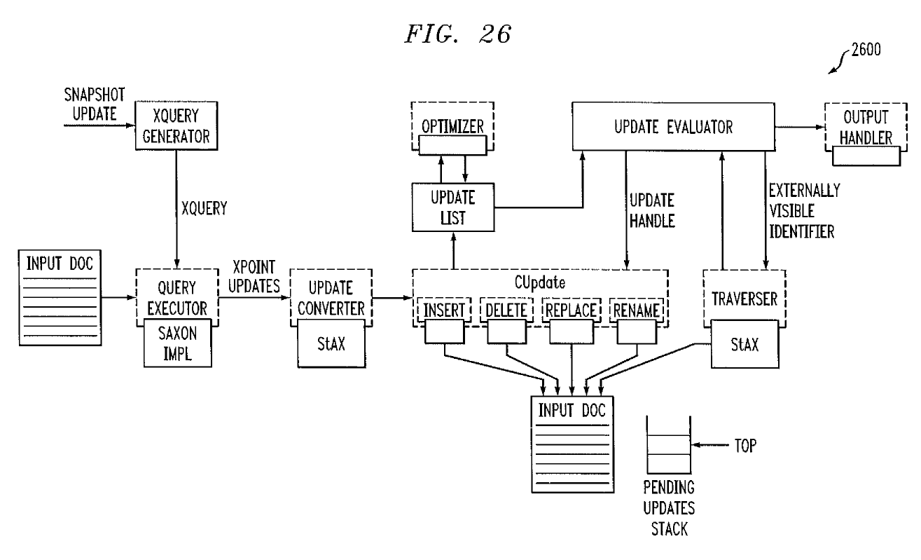

The delete update is implemented using a skip mode to scan the input stream, provided by the StAX Traverser (See FIG. 26). In the skip mode, the Traverser reads the events from the input stream but does not write them to the output stream. The delete implementation uses the skip mode of Traverser to skip through the START_ELEMENT and END_ELEMENT event of the target node and the events corresponding to the descendant nodes of the target node. If there are any updates with a target node as one of the skipped nodes, they are removed by the process( ) method when the method scans the CUpdate list to find the next CUpdate to execute. The method next picks the CUpdate whose target node is either the node identified by the current stream pointer or any node after it.

Unlike “insert into,” this skipping of nodes within the delete implementation is safe because any CUpdate whose target node is in the skipped nodes can be ignored, since lenient semantics are assumed, as discussed above. Still, there can be some pending updates, e.g., insert-after that is associated with the END_ELEMENT event of the target node The StAX Traverser needs to process these pending updates at the end of the skip mode.

Replace:

The replace update is implemented using an insert after and a delete point update. For implementation of a replace update, a pending insert after update is created using the replace content, and it is associated with the END_ELEMENT event of the target node of replace, and pushed on the pending update stack. Next, a delete update is created using the target node of the replace and executed. In doing so, the Traverser skips through all of the events corresponding to the target node and its descendant nodes. At the end of skip mode (i.e., when the END_ELEMENT event corresponding to the target node of replace/delete is read), the pending insert after update is processed. As a result, the replace content is inserted immediately after the deleted node.

In the exemplary StAX implementation, in order to preserve the snapshot semantics, multiple pending CUpdates that are pending for the same END_ELEMENT event must be processed carefully. The following guidelines should control the processing in this case:

The insert into updates should be processed before insert after updates.

The insert into updates should be processed in the order in which they appear in the original CUpdate list.

The insert after updates should be processed in the reverse order in which they appear in the original CUpdate list.

The last guideline may seem counterintuitive, but is necessary for correct implementation of the snapshot semantics. If there is a list of insert after updates with the same target node, it is required that after execution the update content of the last insert after update should immediately follow the target node while that of the first insert after update should be the last. The Last-In-First-Out stack for pending updates ensures that the update content of insert after updates are written in the right order to the output stream. FIG. 26 is a block diagram illustrating an exemplary StAX implementation 2600 of the architecture.

StAX2 Implementation

As explained in the previous subsection, in the StAX implementation, there are some CUpdates that can only be executed once the END_ELEMENT event corresponding to the their target have been read from the input stream. These CUpdates are associated with the END_ELEMENT event of the target node and are stored in a stack as pending updates Although use of a stack to hold the pending updates allows any backtracking in the input stream to be avoided, the approach introduces some bottlenecks in the system.

The size of the pending update stack is directly proportional to the numbers of pending CUpdates During the update evaluation phase, a large number of pending CUpdates can increase the size of the pending update and can lead to the memory thrashing. As an extreme example, an insert into CUpdate whose target node is the last child of the root node, will be kept in the pending stack during the entire duration of update processing and will only be executed when the end of the input stream is reached. Along with the number of pending CUpdates, the size of the update content in these pending CUpdates also affect the size of the stack. Thus, the pending update stack can become a bottleneck if the pending CUpdates contain update contents of large sizes An alternative approach is shown below that allows all the CUpdates to be processed in a single scan of the input document without any backtracking

The pending updates stack in the StAX implementation is required to process the CUpdates in the document order of the target nodes in the input stream. If one processes the CUpdates in an order based on their actual point of execution in the input stream, one can avoid creating pending updates and holding them on the stack. This section describes this alternative implementation, referred to as StAX2

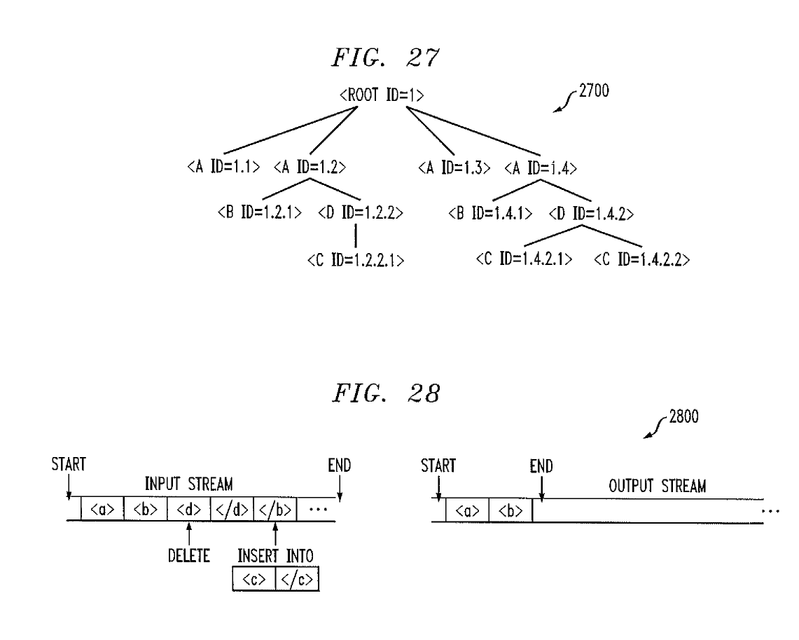

In the StAX2 implementation, Dewey encoding is used as the visible node identification scheme. Using this encoding, the visible identifier of a node can reveal the path information of a node from the root as well its relative position among it peers. For example, FIG. 27 provides an example of an XML document 2700 with visible node identifiers using Dewey encoding. Using this path information (based on the type of CUpdate), it is possible to order the point updates according to there actual point of update execution in the input stream. The optimization architecture allows this with minimum changes to the previous StAX implementation The approach is first illustrated with an example and then the changes made in the StAX implementation are described to get the StAX2 implementation.

In the proposed ordering of CUpdates in StAX2, CUpdates of type insert after or insert into, that correspond to an END_ELEMENT event of the target node, are processed only after CUpdates corresponding to all the descendant nodes of the target node are processed. FIG. 28 provides an example of CUpdate ordering 2800 for the exemplary StAX2 implementation.

The QueryExecutor and UpdateConverter blocks can be implemented in the StAX2 implementation in a similar manner as the StAX implementation, described above. The Optimizer is changed to implement the new ordering, as described hereinafter.

Optimizer:

In a StAX2 implementation, the Optimizer orders the CUpdates in the order of their actual point of execution in the input stream. The optimizer classifies CUpdates into two categories; first associated with the START_ELEMENT event (i.e., that are executed when the START_ELEMENT event of the target node is read from the input stream). The second category of CUpdate consists of those associated with the END_ELEMENT event (i.e, that can only be executed after reading the END_ELEMENT event of the target node). In this new ordering, the CUpdates associated with the START_ELEMENT event are ordered in a document order of their target node as before, but the ordering of point updates associated with the END_ELEMENT event is different and governed by the following rules. Assume P is a CUpdate whose target node is a and Q is a CUpdate whose target node is b then:

If P is an END_ELEMENT CUpdate and b is a descendant of a, then CUpdate Q precedes P in the ordering.

If P is an END_ELEMENT CUpdate and b is not a descendant of a but b follows a in the document order, then CUpdate P precedes Q in the ordering.

Moreover, in StAX2, the CUpdates that have the same target node are ordered differently. Again, the focus is to write the update content to the update stream without backtracking and also to facilitate removal of redundant updates. The order used in this implementation is insert before, delete, rename, replace, replace value, insert as first, insert into, and insert after. Note that when there are multiple insert as first or multiple insert after CUpdates with the same target node, then for these CUpdates, the order must be reversed from the order in which they are generated. This reversal of ordering is required to preserve the snapshot semantics If P and Q are two insert after point updates generated in that order with the same target node a, then according to snapshot semantics, the update content of Q should follow a, followed by update content of P in the updated document. Therefore, the optimizer of StAX2 reverses their ordering to Q followed by P. In general, for a sequence of insert as first and insert after CUpdates with the same target node, update contents of the i+1^{th} CUpdate should be written to the output stream before the update contents of the i^{th} CUpdate

The Dewey encoding used for the visible node identifiers has one additional advantage It allows the removal of a redundant CUpdates (even those that do not have the same target node) in the optimization phase. For example, if there is a delete CUpdate with a target node n, then all the point updates that have target nodes that are descendent's of n can be safely removed. Since the descendant information is easily available using the Dewey encoding, such redundant updates can be removed during optimization as opposed to run time (in the StAX implementation).

Now, the implementation of the Traverser interface in StAX2 is described. Similar to StAX, the traverseToNodeId( ) method of StAX2 Traverser reads the StAX event from the input stream using XML EventReader until the target node is reached. For the CUpdates associated with the START_ELEMENT event, on receiving the required START_ELEMENT event in the input stream, the method returns that event as part of UpdateHandle object. The CUpdates associated with the END_ELEMENT event, however, must be handled differently. The visible node identifier is associated with a START_ELEMENT event of a node For the CUpdates associated with a END_ELEMENT event, it is quite possible that the START_ELEMENT event of their target node would have already been read from the input stream. In such a case, it is difficult to find the END_ELEMENT event corresponding to the target node in the input stream. To handle this case, the Traverser maintains a local stack to map the START_ELEMENT events and corresponding END_ELEMENT events of all the nodes while reading through the input stream. It uses this local stack to find the END_ELEMENT event corresponding to the target node. The method returns this END_ELEMENT event as a part of UpdateHandle object. As shown in the FIG. 28, the Traverser has read through the START_ELEMENT event corresponds to the target node for the insert after CUpdate when it is to be executed. But using the stack the can returns the correct END_ELEMENT event of the target node.

In addition to the traverseToNodeId( ) method, the StAX2 Traverser also provides a set of helper methods that are used by the CUpdates to move to the exact location in the input stream, during the execution, before writing the update contents to the output stream, as follows:

public void traverseBeforeStartTag(Identifier id)

public void traverseAfterStartTag(Idenfifier id)

public void traverseBeforeEndTag(Identifier id)

public void traverseAfterEndTag(Identifier id)

As described above, depending upon the type of update, the traverseToNodeId( ) method returns either the START_ELEMENT event or END_ELEMENT event for a target node. Based on the update type, CUpdate's execute method will use the appropriate method to move to the specific location in the input stream before writing update contents into the output stream.

The implementation of the execute( ) method of CUpdate interface for its various subclasses is now described The implementation for insert before, delete, and replace updates are the same as discussed above for the StAX implementation. The changes made to the execute( ) method of insert as-first, insert into and insert after CUpdates are described.

Insert As-First

In StAX2, Insert as-first CUpdate is handled in a similar manner as the StAX implementation, with one exception. The ordering of a sequence of Insert as-first CUpdates are not reversed with the same target node As described previously, this is done during optimization.

Insert Into

As explained above, the insert-into CUpdate is associated with the END_ELEMENT event of the target node. By the time a point update of type insert into is processed, point updates corresponding to the descendants of this target node if any, are already executed. So using the Traverser API, the execute( ) method reads through the input stream until END_ELEMENT event of the target node is reached and then writes the update content to the output stream before the END_ELEMENT event.

Insert After

Similar to the insert-into update, the insert-after update is also associated with the END_ELEMENT event of the target node in the input stream. The execute( ) method uses the traverse AfterEndTag( ) method of the Traverser to read past the END_ELEMENT event of the target node and then writes the update content into the output stream.

### Processing Sequences of Snapshot Updates

The architecture and implementations described in the previous sections were focused on executing a single snapshot update statement. In this section, the additional components that are required to execute a sequence of snapshot update statements using the disclosed architecture are described.

In a sequence u₁ . . . uₗ₋₁,uₗ . . . uₙ of snapshot updates, it is quite possible that an update uₗ depends upon another update uᵢ₋ₖ. There are two issues that need to be addressed in the disclosed architecture to process a sequence of snapshot update statements correctly. First, after a snapshot update is executed, the architecture requires that the XQuery Executor be re-initialized with the updated copy of the input document and before the next snapshot update in the sequence is processed. Second, the visible identifier of the nodes in the updated document in Update Evaluator should be refreshed between successive execution of two snapshot update statements.

The first requirement is easier to handle, as the output handler can be modified to re-initialize the Query Executor with the modified document. The second issue is comparatively harder since the nodes whose visible identifier need to be updated depend upon the identifier scheme used. A global identifier, such as document order, requires modifications to the identifiers of all the nodes that appear after an updated node in the document. In contrast, a local identifier, such as Dewey encoding, requires changing the identifiers of only the nodes that are in the subtree rooted at the modified node. Regardless of which scheme is used, the visible identifiers need to be updated in both copies of the input document (the copy used for querying and that used for update evaluation). In the remainder of this section, various alternatives are described for updating the integer identifiers based on document order.

The naive approach of updating the visible identifier s is to do a fresh assignment of identifiers for all the nodes in the document. One disadvantage of this approach is that it requires an additional scan of the complete document. In an incremental approach, one can update these identifiers as updates are applied to the input document by the Update Evaluator. A counter is maintained for the current document position in the modified document. Whenever a point update is applied, this counter is used to update the identifiers of nodes in the document as well as assign correct identifiers to any new nodes in the modified document Additionally, a signed offset is computed that is added to this counter after the update is applied, to get the correct document position for the node following the target node of the update. The advantage of this approach is that it does not require an additional scan of the document. It does require, however, processing the body of inserted fragments to add the appropriate identifiers, which can be time-consuming.

The third approach is a computed approach in which the document position of nodes is not inserted into the document. Instead, it is computed in both the querying phase and the update evaluation phase. During the querying phase, the document position of the target node can be computed using the XQuery Count( ) function, i.e., counting the number of preceding nodes in document order. In the update evaluation phase, one can use a simple counter to keep track of the document position of the nodes as it scans through the input document. The advantage of the computed approach is that there is no need to update the identifiers of any node at all. The downside of this approach is that the performance of the querying phase is dependent upon where in the document an update is applied. Since the Count( ) function needs to traverse the document from the beginning node up to the target node, the generation of point updates with the target node in the end of document will take longer than those with the target node in the beginning of the document. In the previous approaches, where these identifiers were inserted into the document, point update generation takes a constant time irrespective of the position of the target node in the document since the identifier of target node is obtained by an attribute lookup.

An exemplary implementation uses the naive approach. The decision of which approach to take is encapsulated in the following places:

The Init method of the Query Executor, which can either simply load the document or pre-process the document to recalculate identifiers.

The XQuery Generator, which can either add the Count( ) within the translated queries or not.

The Update Converter, which will produce CUpdate objects In the computed or naive approach, the execute method of these objects does nothing to identifiers. In the incremental approach, the execute method adds identifiers with inserted content and makes use of offsets that are contained in the Update Handle.

The Init method of the Traverser, which can either refresh the identifiers (in the naive approach) or not.

The traversal methods of the Traverser, which can either simply read identifiers (in the naive approach), calculate counts (in the computed approach) or compute offsets (in the incremental approach).

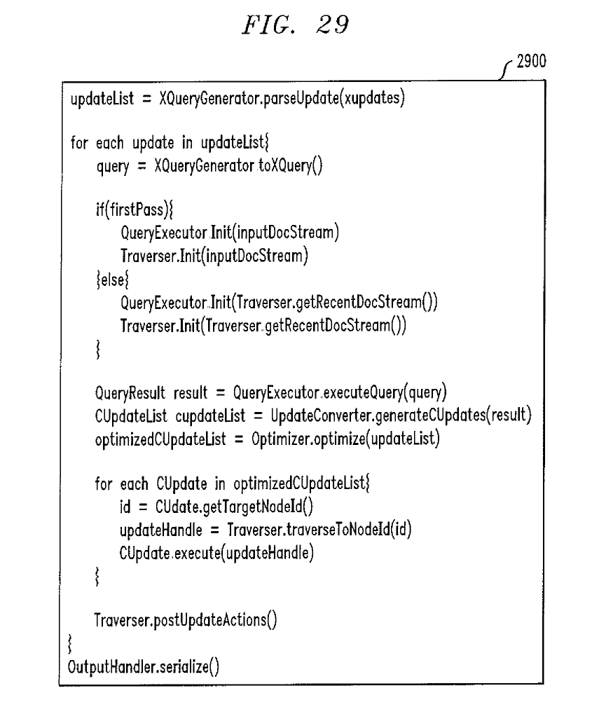

The modified general algorithm 2900 to process a sequence of snapshot statements in the disclosed architecture is shown in FIG. 29.

### Building XML Update Facility

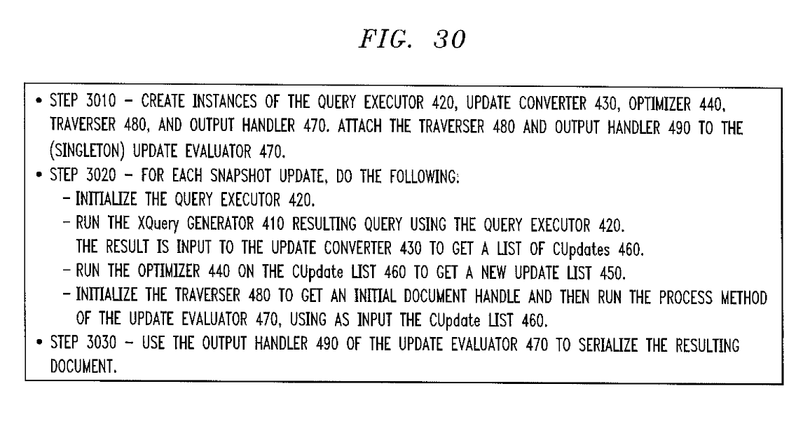

FIG. 30 illustrates an exemplary sequence of steps that are performed to build a complete end-to-end Update facility for XML in accordance with the present invention. As shown in FIG. 30 (and with reference to FIG. 4), during step 3010, instances of the Query Executor 420, Update Converter 430, Optimizer 440, Traverser 480, and Output Handler 470 are created. The Traverser 480 and Output Handler 490 are attached to the (singleton) Update Evaluator 470. During step 3020, for each snapshot update, the following steps are performed:

initialize the Query Executor 420;

run the XQuery Generator 410 resulting query using the Query Executor 420 (the result is input to the Update Converter 430 to get a list of CUpdates 460);

run the Optimizer 440 on the CUpdate list 460 to get a new Update list 450; and

initialize the traverser 480 to get an initial Document Handle and then run the process method of the Update Evaluator 470, using as input the CUpdate list 460.

During step 3030, the Output Handler 490 of the Update Evaluator 470 is used to serialize the resulting document.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular The memories could be implemented as an electrical, magnetic or optical memory, or any combination of these or other types of storage devices Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A modular system for updating an XML document, comprising:
a query generator for converting one or more updates to said XML documents into one or more queries;
an existing XML query engine for processing said one or more queries to generate one or more point updates that each update a node in said XML document;
an update converter that converts said one or more point updates to one or more abstract interface representations of said one or more point updates, wherein said one or more abstract interface representations are executable units that can be individually executed using a point update facility; and
an update evaluator that applies said one or more abstract interface representations to said XML document to update said XML document.

2. The modular system of claim 1, wherein said abstract interface representations are implemented using said point update facility of a document object model.

3. The modular system of claim 1, wherein said abstract interface representations are implemented using a stream-based point update facility.

4. The modular system of claim 3, wherein said stream-based point update facility employs a pull-based streaming API.

5. The modular system of claim 4, wherein said streaming API is StaX.

6. The modular system of claim 1, wherein said update evaluator processes a collection of said abstract representations of one or more point updates.

7. The modular system of claim 1, further comprising a point update optimizer that reorders said one or more point updates.

8. The modular system of claim 7, wherein said point updates are reordered based on an order of application of said point updates in a stream representing said XML document.

9. The modular system of claim 1, wherein said update evaluator employs a pull-based streaming API

10. The modular system of claim 9, wherein said streaming API is StaX.

11. A method for updating an XML document, comprising:
converting one or more updates to said XML documents into one or more queries;
processing said one or more queries using an existing XML query engine to generate one or more point updates that each update a node in said XML document;
converting said one or more point updates to one or more abstract interface representations of said one or more point updates, wherein said one or more abstract interface representations are executable units that can be individually executed using a point update facility; and
applying said one or more abstract interface representations to said XML document to update said XML document.

12. The method of claim 11, wherein said abstract interface representations are implemented using said point update facility of a document object model.

13. The method of claim 11, wherein said abstract interface representations are implemented using a stream-based point update facility.

14. The method of claim 13, wherein said stream-based point update facility employs a pull-based streaming API.

15. The method of claim 11, wherein said update evaluator processes a collection of said abstract representations of one or more point updates.

16. The method of claim 11, further comprising the step of reordering said one or more point updates.

17. The method of claim 16, wherein said point updates are reordered based on an older of application of said point updates in a stream representing said XML document.

18. The method of claim 11, wherein said update evaluator employs a pull-based streaming API.

19. An article of manufacture for updating an XML document, comprising a machine readable medium containing one or more programs which when executed implement the steps of:
converting one or more updates to said XML documents into one or more queries;
processing said one or more queries using an existing XML query engine to generate one or more point updates that each update a node in said XML document;
converting said one or more point updates to one or more abstract interface representations of said one or more point updates, wherein said one or more abstract interface representations are executable units that can be individually executed using a point update facility; and
applying said one or more abstract interface representations to said XML document to update said XML document

20. The article of manufacture of claim 19, wherein said abstract interface representations are implemented using one or more of said point update facility of a document object model and a stream-based point update facility.
